(19) United States
(12) Patent Application Publication
(10) Pub. No.: US 2012/0121937 A1
(43) Pub. Date: May 17, 2012

(54) BATTERY PACK

(75) Inventors: Eun-Ok Kwak, Yongin-si (KR); Jeong-Deok Byun, Yongin-si (KR); Kyung-Won Seo, Yongin-si (KR); Jin-Hong An, Yongin-si (KR)

(73) Assignee: Samsung SDI Co., Ltd., Yongin-si (KR)

(21) Appl. No.: 13/078,213

(22) Filed: Apr. 1, 2011

(30) Foreign Application Priority Data
Nov. 11, 2010 (KR) 2010-0112077

(51) Int. Cl. H01M 10/42

(52) U.S. Cl. 429/7

(57) ABSTRACT

A battery pack is constructed with a plurality of bare cells having first and second electrodes, a protection circuit module having at least one through-holes, a first electrode lead electrically connecting the first electrodes and a second electrode lead electrically connecting the second electrodes, and a holder case having supports that support the bare cells. One end of each first and second electrode leads passes through the through-hole of the protection circuit module. The first and second electrode leads electrically connect the bare cells and balance the bare cells by transmitting at least one of voltage and current of the bare cells to the protection circuit module.

### CLAIM OF PRIORITY

This application makes reference to, incorporates the same herein, and claims all benefits accruing under 35 U.S.C. §119 from an application for BATTERY PACK earlier filed in the Korean Intellectual Property Office on Nov. 11, 2010 and there duly assigned Serial No. 10-2010-0112077.

### BACKGROUND

1. Field of the Invention

The present invention relates to a secondary battery, in more detail, a battery pack including a plurality of secondary batteries and a protection circuit module electrically connected with the secondary batteries.

2. Description of the Related Art

Recently, mobile electronic devices have been increasingly spread with the IS rapid development of the electronic and communication industries. Secondary batteries are widely used for supplying power of the mobile electronic devices, in consideration of economical efficiency.

Further, the secondary batteries can be used for middle and large apparatuses, such as electric tools, electric bicycles, and vehicles, which require high output and high power, in addition to mobile phones and notebooks. The middle and large apparatuses require a high-output and high-power power source, such that the secondary batteries are used in a battery pack that is used as one power source by connecting a plurality of secondary batteries in parallel or series.

### SUMMARY OF THE INVENTION

One aspect of the present invention provides an improved battery pack. Another aspect of the present invention provides a battery pack where a plurality of secondary batteries are firmly mounted.

Still another aspect of the present invention provides a battery pack that does not need specific wires for cell balancing.

A further aspect of the present invention provides a battery pack electrically connected to a power source without soldering by connecting a high current terminal of the battery pack via a pattern.

In order to achieve the objects of the present invention, according to an aspect of the present invention, a battery pack is constructed with a plurality of bare cells having first and second electrodes, a protection circuit module having at least one through-hole, a first electrode lead electrically connecting the first electrodes and a second electrode lead electrically connecting the second electrodes, and a holder case having supports that support the bare cells. One end of each other first and second electrode leads passes through the through-hole of the protection circuit module. The first and second electrode leads electrically connect the bare cells and balance the bare cells by transmitting at least one of voltage and current of the bare cells to the protection circuit module.

The through-holes may be disposed at a predetermined distance from each other on the protection circuit module.

The through-holes may have rectangular or elliptical cross-sections perpendicular to the direction in which the first and second electrode leads pass through the protection circuit module. The through-holes may have cross-sections tapered to decrease in width in parallel with the direction in which the first and second electrode leads pass through the protection circuit module, and end portions of the first and second electrode leads that pass through the through-holes may have shapes corresponding to the cross-sectional shapes of the through-holes in parallel with the direction in which the first and second electrode leads pass through the protection circuit module.

The protection circuit module may include a component side facing the sides of the bare cells and a solder side opposite to the component side. The solder side may have solder lands around the through-holes and the first and second electrode leads may be connected to the through-holes by soldering. The solder land may contain copper, plated gold, or tin.

The protection circuit module may further include a pattern connecting high current terminals of the battery pack and fastening portions connecting wires inducing power from the high current terminals. The fastening portions may be holes that are fastened to the wires by screws and may be fastened to the wires by hook fastening or groove-protrusion fastening.

The first and second electrode leads may contain nickel or copper.

The end portions of the first and second electrode leads which pass through the through-holes may have shapes corresponding to the through-holes.

The supports of the holder case may have shapes corresponding to the sides of the bare cells. The holder case may have a height corresponding to the sides of the bare cells. The perpendicular side of the holder case facing the protection circuit module may be higher than the protection circuit module.

The first and second electrode leads may be alternately arranged and the bare cells may have cylindrical or polygonal shapes.

According to the present invention described above, it is possible to provide a battery pack where a plurality of secondary batteries are firmly mounted.

Further, according to the present invention, it is possible to provide a battery pack that does not need specific wires for cell balancing. Therefore, according to the battery pack of the present invention, it is possible to reduce the number of parts and decrease the manufacturing cost by reducing the number of processes of connecting the wires.

Further, according to the present invention, it is possible to provide a battery pack including a power source connected without soldering by connecting high current terminals via a pattern. Therefore, the battery pack can prevent defects in processes due to soldering and the high current terminals connected in the way described above can be firmly connected in comparison to soldering, such that the battery pack can be stably used without being damaged by external shock.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an oblique view of a secondary battery included in a battery pack constructed as an embodiment according to the principles of the present invention;

FIG. 2 is an oblique view of a battery pack constructed as an embodiment according to the principles of the present invention;

FIG. 3 is an enlarged view of portion A shown in FIG. 2;

FIG. 4A is an enlarged view of portion B shown in FIG. 2;

FIG. 4B is a view showing a fastening portion of a high current terminal of portion B shown in FIG. 2 and an external wire as an embodiment according to the principles of the present invention; and

FIG. 5 is an enlarged view of a portion where first and second electrode leads and a protection circuit module are connected.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

The details of other embodiments are included in the detailed specification and the drawings.

Advantages and features of the present invention and methods to achieve them will be elucidated from exemplary embodiments described below in detail with reference to the accompanying drawings. However, the present invention is not limited to the embodiment described hereafter and may be implemented in various ways. Further, connection of a part with another part includes direct connection and electric connection of the parts with another device therebetween in the following description. Further, the parts not related to the present invention are removed in order to make the description of the present invention clear, and like components are given like reference numerals throughout the specification.

Hereinafter, the present invention is described with reference to the accompanying drawings.

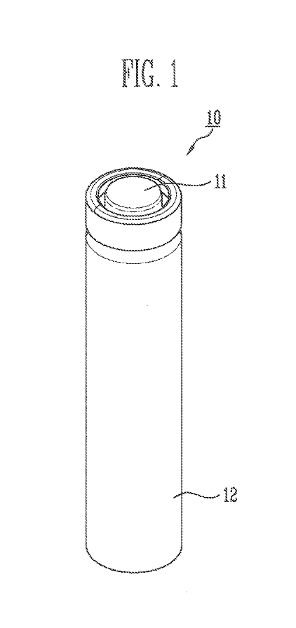

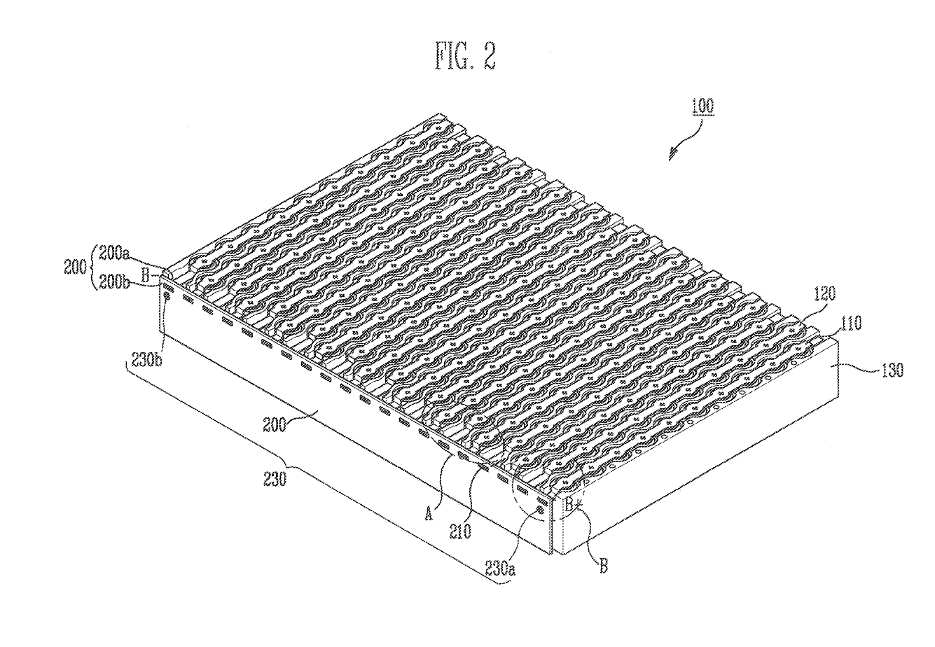

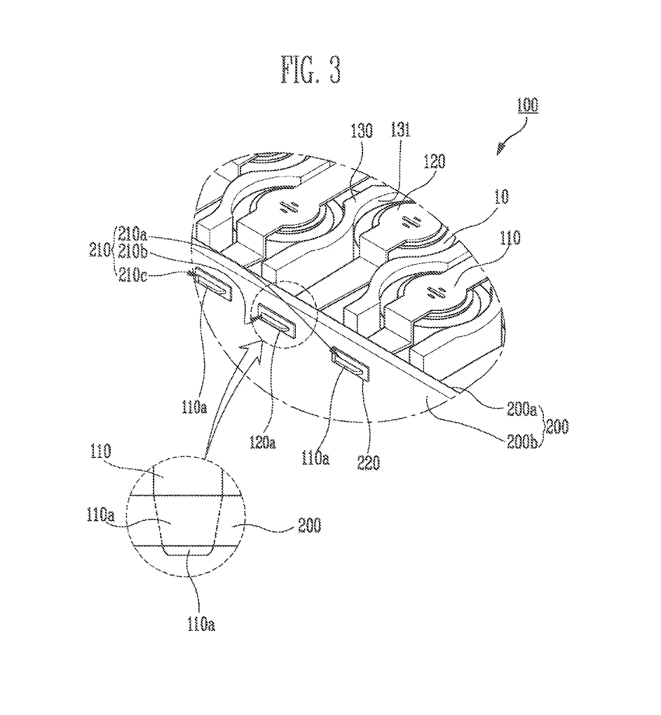

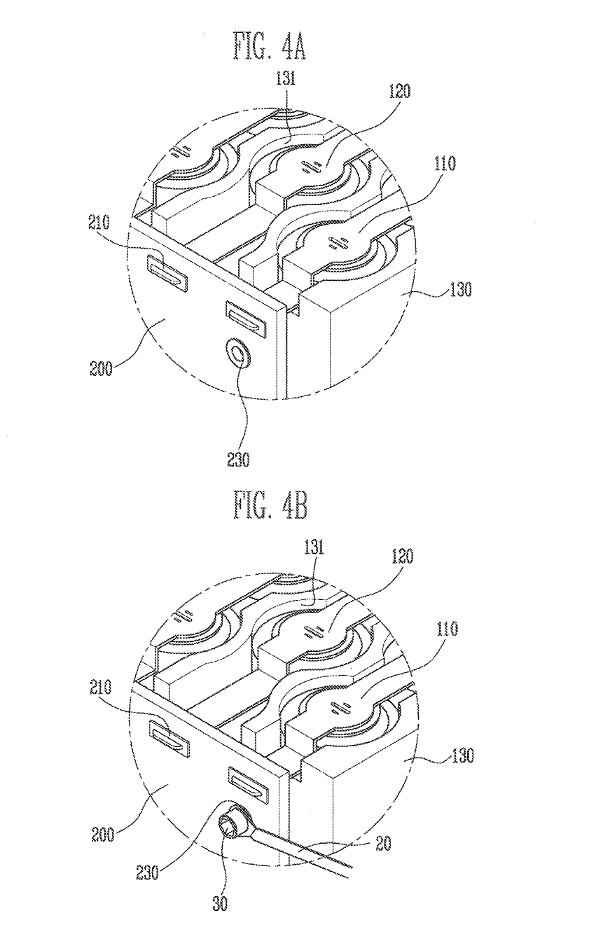

FIG. 1 is an oblique view of a secondary battery included in a battery pack constructed as an embodiment according to the principles of the present invention and FIG. 2 is an oblique view of a battery pack constructed as an embodiment according to the principles of the present invention. FIG. 3 is an enlarged view of portion A shown in FIG. 2, FIG. 4A is an enlarged view of portion B shown in FIG. 2, and FIG. 4B is a view showing a fastening portion of a high current terminal of portion B shown in FIG. 2 and an external wire.

Referring to FIGS. 1 and 2, a battery pack 100 constructed as the embodiment of the present invention includes a plurality of bare cells 10 having first and second electrodes 11, 12, a protection circuit module 200 having one or more through-holes 210, a first electrode lead 110 connecting first electrodes 11 of the plurality of bare cells 10 and a second electrode lead 120 connecting second electrodes 12 of the plurality of bare cells 10, and a holder case 130 supporting bare cells 10. First and second electrode leads 110, 120 electrically connect bare cells 10 with protection circuit module 200 through through-holes 210 of protection circuit module 200. Further, first and second electrode leads 110, 120 electrically connect bare cells 10 and can balance bare cells 10 by transmitting any one or more of voltage and current of bare cells 10 to protection circuit module 200.

First, referring to FIG. 1, bare cell 10 included in battery pack 100 according to the present invention may have a polygonal or cylindrical shape, but is not limited thereto. That is, bare cell 10 is a chargeable/rechargeable secondary battery and the shape may be appropriately changed in accordance with the design of battery pack 100. Battery cell 10 has a cylindrical shape in this embodiment.

Bare cell 10 is composed of a can 12 having an opening and a cap assembly 11 closing the opening of can 12. Further, the bottom of bare cell 10 is positioned to correspond to the opening of can 12. Though not shown, an electrode assembly and an electrolyte may be accommodated in can 12. The electrode assembly is formed by spirally winding an anode plate, a cathode plate, and a separator interposed between the electrode plates. The anode plate and the cathode plate are provided with electrode taps made of nickel or copper. The electrode tap of the anode plate is connected to cap assembly 11 and the electrode tap of the cathode plate is connected to the bottom of can 12. Therefore, cap assembly 11 can function as an anode terminal and can 12 can function as a cathode terminal. A gasket (not shown) is disposed between cap assembly 11 and can 12 and electrically insulates cap assembly 11 and can 12. Electric energy generated by a chemical reaction between the plates and the electrolyte is transmitted to the outside of bare cell 10 through the electrode taps.

Referring to FIG. 2, first electrode lead 110 and second electrode lead 120 respectively connect bare cells 10 in parallel. In detail, first electrode lead 110 connects cap assemblies 11 of bare cells 10 and second electrode lead 120 connects cans 12 of bare cells 10, particularly the bottoms of cans 12. Therefore, first electrode lead 110 functions as an anode terminal and second electrode lead 120 functions as a cathode electrode.

Assuming that first electrode terminal 110 and bare cells 10 connected by first electrode terminal 110 make a first cell group, and second electrode terminal 120 and bare cells 10 connected by second electrode terminal 120 make a second cell group, the first cell groups and the second cell groups are alternately arranged. Therefore, the anode terminals and the cathode terminals are alternately arranged and electrically connected to protection circuit module 200. Further, holder case 130 may be disposed between the first and second cell groups. Holder case 130 includes supports 131 supporting bare cell 10. Holder case 130 determines and maintains the position of bare cells 10 such that bare cells 10 do not move in battery pack 100.

In the drawings, B+ and B− indicate high current terminals, which function as power sources at both ends of bare cells 10. B+ designates the highest potential terminal as an anode power source and B− designates the lowest potential terminal as a cathode power source.

The structure of battery pack 100 according to this embodiment is described hereafter in detail with FIGS. 2 to 4B.

Referring to FIG. 2, battery pack 100 includes a plurality of bare cells 10, holder case 130 supporting bare cells 10, and protection circuit module 200 disposed at one side of bare cells 10. Bare cells 10 are connected by first or second electrode lead 110, 120.

Protection circuit module 200 is electrically connected with bare cells 10. Protection circuit module 200 prevents bare cells 10 from being overcharged or overdischarged by controlling the voltage and current which are applied to bare cells 10 when bare cells 10 are charged/discharged. Therefore, components, such as a protection device or an external terminal, which controls the voltage or the current of bare cells 10 may be mounted on protection circuit module 200.

Protection circuit module 200 may include through-holes through which first and second electrode leads 110, 120 pass. Through-holes 210a, 210b, 210c may be one or more and through-holes 210a, 210b, 210c may be disposed at a distance from each other on protection circuit module 200.

Through-holes 210 may have a rectangular or elliptical cross-section perpendicular to the direction in which first and second electrode leads 110, 120 pass through protection circuit module 200. Further, through-holes 210 may have a rectangular or tapered cross-section parallel with the direction in which first and second electrode leads 110, 120 pass through protection circuit module 200. For example, as shown in FIG. 3, through-holes 210 may have a tapered cross-section that decreases in width and is parallel with the direction in which first and second electrode leads 110, 120 pass through protection circuit module 200. In this configuration, the portions of first and second electrode leads 110, 120 which pass through through-holes 210 of protection circuit module 200 may have shapes corresponding to the shapes of through-holes 210. That is, when through-holes 210 are tapered, ends 110a, 120a of the first and second electrode lead may be correspondingly tapered.

Through-holes 210 and ends 110a, 120a of first and second electrode leads 110, 120 are not limited to those shown in the drawings. That is, the shapes of through-holes 210 and ends 110a, 120a of the first and second electrode leads may be appropriately changed, as long as first and second electrode leads 110, 120 can pass through through-holes 210.

Protection circuit module 200 may be a thin plate. Protection circuit module 200 may has a component side 200a and a solder side 200b opposite to component side 200a. Component side 200a is a surface where components, such as a protection device, are mounted, and faces bare cells 10. Solder side 200b is a surface that is usually soldered. In solder side 200b, solder lands 220 may be provided around through-holes 210. Solder lands 220 are conductors exposed on the surface of protection circuit module 200 in order to connect the components. First and second electrode leads 110, 120 are soldered to solder lands 220, through through-holes 210. For example, solder land 220 may contain copper, plated gold, or tin.

Further, referring to FIGS. 4A and 4B, protection circuit module 200 may further include fastening portions 230a, 230b (see FIG. 2) respectively connecting high current terminals B+, B− (see FIG. 2) to the outside. Fastening portion 230 may be one or more holes. In this configuration, high current terminals B+, B− are respectively connected to fastening portions 230 through a circuit pattern formed in protection circuit module 200 and fastening portions 230 may be fastened to a wire 20 by screws 30. Accordingly, it is possible to remove the soldering process and reduce the material cost because specific wires are not required, when power is induced from high current terminals B+, B−.

In this embodiment, fastening portions 230 are connected to wire 20 by screws 30, as described above, but are not limited thereto. For example, fastening portions 230 may be fastened in various ways, such as hook fastening or groove-protrusion fastening, to be connected with wire 20. For example, first and second electrode leads 110, 120 may contain nickel or copper etc. In first and second electrode leads 110, 120, the portions where first and second electrode leads 110, 120 pass through through-holes 210 may be formed to correspond to through-holes 210.

Battery packs used for mobile phones include one or two bare cells therein; however, battery packs used for electric vehicles may include 150 to 200 or more bare cells. The battery packs are required to be controlled by monitoring the state of the bare cells (cell balancing). In order to perform the cell balancing, wires should be connected to the bare cells in the battery packs and the number of wires depends on the number of bare cells. Therefore, when the number of wires increases a predetermined value, the wires may be entangled in the battery packs because they are complicated. The wires may cause interference with the battery case and may also increase the volume of the battery packs.

On the contrary, in battery pack 100 according to the present invention, first and second electrode leads 110, 120 not only connect bare cells 10 in parallel or series, but make it possible to monitor the state of bare cells 10 by transmitting the voltage or current of bare cells 10 to protection circuit module 200. Therefore, battery pack 100 according to the present invention does not need specific wires in order to perform cell balancing. That is, since battery pack 100 according to the present invention can perform cell balancing even without specific wires, it is possible to reduce the volume of battery pack 100 and increase productivity by simplifying the manufacturing process.

As described above, holder case 130 may include supports 131 supporting bare cells 10. Supports 131 support bare cells 10, facing the sides of bare cells 10. Therefore, bare cells 10 can be stably fixed without moving in battery pack 100 and are not easily damaged by external shock.

It is preferable that supports 131 of holder case 130 have a shape corresponding to bare cells 10. That is, it is preferable that the height of holder case 130 is close to the height of bare cells 10 while supports 131 that are the surfaces where holder case 130 and bare cells 10 are in contact are formed in a shape corresponding to the sides of bare cells 10. The larger the area where holder case 130 and bare cells 10 are in contact, the more bare cells 10 can be stably fixed by holder case 130.

Further, it may be more preferable that holder case 130 has the height corresponding to the sides of bare cells 10 and is higher than protection circuit module 200. It is possible to prevent interference between protection circuit module 200 and holder case 130 and reduce the volume of battery pack 200 by reducing the height of protection circuit module 200, when bare cells 10 and protection circuit module 200 are cased. Holder case 130 may be made of an insulating material, such as polymer resin.

In battery pack 100 constructed as this embodiment, first electrode lead 110 and second electrode lead 120 may function as an anode terminal and a cathode terminal, respectively. First and second electrode leads 110, 120 are alternately arranged and first and second electrode leads 110, 120 and holder case 130 may be disposed perpendicular to protection circuit module 200.

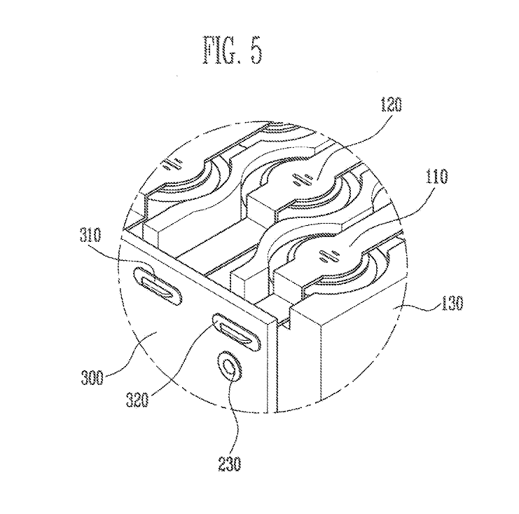

FIG. 5 is a view showing a battery pack constructed as another embodiment according to the principles of the present invention.

The battery pack according to this embodiment includes a protection circuit module 300, bare cells 10, first and second electrode leads 110, 120, and a holder case 130.

FIG. 5 is a view enlarging the portion where first and second electrode leads 110, 120 and protection circuit module 300 are connected, in the battery pack according to this embodiment. Referring to FIG. 5, through-holes 310 with solder lands 320 are formed in protection circuit module 300. Protection circuit module 300 includes one or more through-holes 310 and first and second electrode leads 110, 120 are soldered through through-holes 310.

As shown in FIG. 5, in the battery pack according to this embodiment, through-holes 310 are formed in circular shapes that first and second electrode leads 110, 120 pass through. In detail, since first and second electrode leads 110, 120 are thin plates, through-holes 310 may be ellipses. Further, solder lands 320 around through-holes 310 may also be ellipses corresponding to the shape of through-holes 310. In this configuration, since through-holes 310 can strengthen the solder of first and second electrode leads 110, 120, first and second electrode leads 110, 120 are not easily separated from protection circuit module 200 by external shock. The configuration of the battery pack, other than those described above, is the same as those described with reference to FIGS. 1 to 4A, such that the detailed description is not provided.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and-equivalents thereof.

What is claimed is:

1. A battery pack, comprising:
a plurality of bare cells having first and second electrodes;
a protection circuit module having at least one through-hole;
a first electrode lead electrically connecting the first electrodes and a second electrode lead electrically connecting the second electrodes; and
a holder case having supports that support the bare cells,
with one end of each first and second electrode leads passing through the through-hole of the protection circuit module, and
the first and second electrode leads electrically connecting the bare cells and balancing the bare cells by transmitting at least one of voltage and current of the bare cells to the protection circuit module.

2. The battery pack according to claim 1, wherein the through-holes are disposed at a predetermined distance from each other on the protection circuit module.

3. The battery pack according to claim 1, wherein the through-holes have rectangular or elliptical cross-sections perpendicular to a direction in which the first and second electrode leads pass through the protection circuit module.

4. The battery pack according to claim 1, wherein the through-holes have cross-sections tapered to decrease in width in parallel with a direction in which the first and second electrode leads pass through the protection circuit module, and
end portions of the first and second electrode leads that pass through the through-holes have shapes corresponding to the cross-sectional shapes of the through-holes in parallel with the direction in which the first and second electrode leads pass through the protection circuit module.

5. The battery pack according to claim 1, wherein the protection circuit module has a component side and a solder side opposite to the component side,
the component side faces the bare cells, and
the solder side is where the first and second electrode leads are soldered.

6. The battery pack according to claim 5, wherein the solder side has solder lands around the through-holes and the first and second electrode leads are connected to the solder lands around the through-holes by soldering.

7. The battery pack according to claim 6, wherein the solder land comprises at least one material selected from a group of copper, plated gold, and tin.

8. The battery pack according to claim 1, wherein the protection circuit module further comprises a pattern connecting high current terminals of the battery pack and fastening portions connecting wires inducing power from the high current terminals.

9. The battery pack according to claim 8, wherein the fastening portions are holes that are fastened to the wires by screws.

10. The battery pack according to claim 8, wherein the fastening portions are fastened to the wires by hook fastening or groove-protrusion fastening.

11. The battery pack according to claim 1, wherein end portions of the first and second electrode leads which pass through the through-holes have shapes corresponding to the cross-sectional shapes of the through-holes in the direction in parallel with the direction in which the first and second electrode leads pass through the protection circuit module.

12. The battery pack according to claim 1, wherein the supports of the holder case have shapes corresponding to sides of the bare cells.

13. The battery pack according to claim 1, wherein the holder case has a height corresponding to sides of the bare cells and a perpendicular side of the holder case facing the protection circuit module is higher than the protection circuit module.

14. The battery pack according to claim 1, wherein the first and second electrode leads are alternately arranged.
